(19) United States
(12) Patent Application Publication
(10) Pub. No.: US 2005/0285056 A1
(43) Pub. Date: Dec. 29, 2005

(54) Process for manufacture of semiconductor chips utilizing a posteriori corrections to machine control system and settings

(76) Inventors: Adlai H. Smith, Escondido, CA (US); Robert O. Hunter JR., Snowmass Village, CO (US)

Correspondence Address: DAVID A. HALL;HELLER EHRMAN LLP, 4350 LA JOLLA VILLAGE DRIVE #700, 7TH FLOOR, SAN DIEGO, CA, 92122, US

(21) Appl. No.: 11/150,330

(22) Filed: Jun. 10, 2005

Related U.S. Application Data
(60) Provisional application No. 60/578,909, filed on Jun. 11, 2004.

(51) Int. Cl. G01N 21/86

(52) U.S. Cl. 250/548; 355/55

(57) ABSTRACT

Methods and apparatus utilizing a posteriori adjustments to a projection imaging machine used in manufacturing of semiconductor integrated circuits are described. Measurements of degradation in a lithography processing of a projection imaging tool or machine are provided. The operation of the projection imaging tool is adjusted in response to the measurements. The projection imaging machine or tool can be adjusted in a single adjustment, or in a series of sub-adjustments. Likewise, only a single machine may be adjusted, or multiple machines used in the manufacture of semiconductor integrated circuits may be adjusted. The measurements may be made using in-situ metrology tests. A database including historical and current machine states may be utilized in determining degradation of the lithography processing.

### REFERENCE TO PRIORITY DOCUMENT

This application claims the benefit of priority of U.S. Provisional Patent Application Ser. No. 60/578,909, entitled “Process for Manufacture of Semiconductor Chips Utilizing a Posteriori Corrections to Machine Control System and Settings”, filed Jun. 11, 2004. Priority of the filing date of Jun. 11, 2004 is hereby claimed, and the disclosure of U.S. Provisional Patent Application Ser. No. 60/578,909 is hereby incorporated by reference.

### FIELD OF INVENTION

Relates to manufacturing of semiconductors and specifically to photolithography.

### BACKGROUND

Roadmaps for semiconductor lithography that project continual shrinkage of feature size have been developed and indicate a need for increased manufacturing capability (see, for example, “International Technology Roadmap for Semiconductors, 2001 Edition, Lithography”, Semiconductor Industry Association, 2001). Some portion of this increased manufacturing capability will come from reduced wavelength (λ) EUV (see, H. Chapman et al., “First Lithographic Results from the Extreme Ultraviolet engineering Test Stand”, J. Vac. Scie. Technology, B 19(6), November/December 2001) or 157 nm optical lithography and increased projection imaging optic (lens) numerical aperture (NA). Immersion particularly increases NA (see, “Development of ArF Immersion Stepper for Mass-Production Applications”, Nikon Press Release available at www.nikon.co.jp/main/eng/news/2004immersion_e_{—}04.htm, 2004, pp. 1-3). However, decreased process variation and machine-to-machine matching in the lithography cell is required to achieve the projected small process windows (see, “International Technology Roadmap for Semiconductors, 2001 Edition, Lithography, supra). Increased use of system on chip (SOC) architectures push application specific integrated circuit (ASIC) and processor overlay requirements into the dynamic Random Access memory (DRAM) domain (see, “ASC9: 90 nm CMOS Process Technology The Industry's First Practical 90 nm Embedded DRAM Process”, Sony Corporation, pp. 1-4).

Some recent techniques for process control that utilize structures on product masks and wafers are capable of allowing manufacturers to adjust gross focus or focal plane tilt, dose and low order distortion (see C. Ausschnitt et al., “Method for Overlay Control System”, U.S. Pat. No. 5,877,861, issued Mar. 2, 1999 and C. Ausschnitt et al, “Process for Controlling Exposure Dose or Focus Parameters Using Tone Reversing Pattern”, U.S. Pat. No. 5,976,740, issued Nov. 2, 1999).

Memory Manufacturing Steps

DRAM and other memory manufacturing processes are generally discussed in “ASC9: 90 nm CMOS Process Technology The Industry's First Practical 90 nm Embedded DRAM Process”, supra, “EE141-Fall 2003 Digital Integrated Circuits”, EE141—Lecture 28 Memory Perspectives, 2003, and J. Binder, “Micro, Nano and Below”, CeBIT 2003, Hannover, 2003, pp. 1-11. FIG. 1 shows plan view of a portion of a DRAM memory cell structure. A partial cross-section AA is shown in FIG. 2 with vias, V, and metal bit lines, B. Transverse (X and Y) alignment of one layer to another is typically the chip parameter with the lowest process capability (C_{PK}, see, NIST “Engineering Statistics Handbook”, October 2002). The effect of transverse misalignment of the bit lines to the vias V or contact holes is shown in FIG. 3 where bit line B is shifted an amount ΔX from via V large enough to cause device failure.

ASIC or Microprocessor Manufacturing Steps

In ASIC or microprocessor manufacturing, the variation of the gate linewidth of individual transistors is the chip parameter with the lowest C_{PK} and thus the most difficult to achieve. D. Chesebro et al., “Overview of Gate Linewidth Control in the Manufacture of CMOS Log Chips”, IBM J. Res. Development, January/March 1995, pp. 189-200 discusses the overall impact of gate linewidth in VLSI MOSFET transistors. FIG. 4 is a schematic cross-section of a generic prior art MOS integrated circuit transistor up through the first metal layer, M. Tungsten, W, vias connect source, gate, and drain to M. The effect of transverse misalignment ΔX on metal layer M is shown in FIG. 5. There, a large enough transverse misalignment will cause patterned metal layer M to not overlap at all with Tungsten via plug W resulting in complete circuit failure. This is just one example of failure or yield loss through misalignment. Turning to FIG. 6, we see the prior art process flow for fabricating a MOS integrated circuit transistor from a bare silicon (Si) wafer up through the first metal layer. As can be appreciated from this explicit recitation of the process flow, there are numerous instances where a transverse error can impact device yield. In the following, we refer to the collection of prior art process steps for making the integrated circuit as the process of reference (POR). As such, FIG. 6 is only a partial recitation of a complete POR.

Process Variation

A simple example of process variation is shown in FIGS. 7 and 8. In FIG. 7 the projected image field (PIF) of a particular machine, MM1 (not shown), and 2 field points (A and B) separated in the X direction is shown. If there is a systematic focus error at field points A and B on MM1 (lens field curvature is one cause), then this will be added to the common random causes of process variation such as field to field focus and dose error to produce the separate process variation windows A′ and B′ of FIG. 8. In FIG. 8, gate linewidth, a critical performance parameter, is plotted versus focus, F, at several exposure dose (E1, E2, E3) values. Region A′ depicts the total centroid and variation in focus and dose encountered at field point A while B′ corresponds to field point B. B′ is shifted in focus because of systematic (e.g., repeatable) focal error between field points A and B. Thus, this process on machine MM1 has a process variation in focus (PVF in FIG. 8) larger than it could be (IPVF in FIG. 8) because of the systematic focus variation. It would be desirable to have a technique for realizing focus variation IPVF since this would improve machine MM1's process capability on chip layers it is currently qualified for and possibly qualify MM1 for chip layers it is currently unqualified for.

For ease of illustration, the previous discussion was restricted to transverse misalignment and focus. The influence of lens aberrations on DRAM feature placement is discussed in R. Holscher et al., “Effect of Lens Aberrations on Pattern Placement Error”, Proc. Of SPIE, Vol. 4000, March 2000 and N. Seong et al., “Pattern Displacement Error Under Off Axis Illumination”, Jpn J. Applied Physics, Vol. 37, December 1998, pp. 6695-6697, while their influence on process variability is discussed in J. Gortych et al., “Effects of Higher-Order Aberrations on the Process Window”, Proc. Of SPIE, Vol. 1463, 1991, pp. 368-381. The effect of the illumination source (e.g., light source and combined scrambling and condenser optics) on process variability and feature shifts is in D. Peters, “The Effects of an Incorrect Condenser Lens Setup on Reduction Lens Printing Capabilities”, Interface 85, Kodak Publ., No. G-154, 1985 pp. 66-72, and Y. Borodovsky, “Impact of Local Partial Coherence Variations on Exposure Tool Performance”, Proc. of SPIE, Vol. 2440, 1995, pp. 750-770. N. Sullivan, “Semiconductor Pattern Overlay”, Proc. Of SPIE Critical Reviews, Vol. CR52, pp. 160-188 contains a discussion of various transverse overlay error sources.

The time scale for the causes of process variation is significant when we wish to correct the causes; weekly or semi-weekly measurement of a machine setting we adjust once a month will improve a manufacturing process while the same metrology/adjustment schedule for causes that vary from wafer to wafer (˜1 minute time difference) will degrade it. Table 1 lists some process variation causes and their typical variation period. Most of these have variation periods of more than one week. The ones relating to reticle or wafer stage motion will have a repeatable part (typically determined as the average) that varies on a time scale of more than one day. Because of the relative constancy of these process variation causes, it would be desirable to directly measure and adjust the machines on a fab floor to minimize these sources of process variation.

TABLE 1
Some process variation causes, their typical variation period
and some reasons for slow variation in the causes.

| | Typical | |
|---|---|---|
| | Variation | Some reasons for slow |
| Process Variation Cause | Period | variation |
| static/dynamic lens | >1 week | Glass compaction/ |
| aberrations | | rarefaction. |
| | | Creep in lens mounting. |
| source | >1 week | Laser beamtrain optical |
| | | component degradation. Laser |
| | | wavelength calibration drift. |
| exit pupil | >1 week | Absorbing film buildup and/ |
| | | or anti-reflection coating |
| | | degradation of projection |
| | | optics. |
| static lens distortion | >1 week | Glass compaction/ |
| | | rarefaction. Creep in lens |
| | | mounting. Drift in lens |
| | | manipulators. |
| dynamic lens distortion | >1 week | Glass compaction/ |
| | | rarefaction. Creep in lens |
| | | mounting. Drift in lens |
| | | manipulators. |
| dynamic scan | >1 day | Interferometer drift. |
| synchronization (average) | | Reference frame drift of |
| | | reticle and wafer |
| | | interferometer subsystems. |
| wafer stage grid & yaw | >1 day | Interferometer drift. |
| (average) | | |
| static lens field | >1 week | Glass compaction/ |
| curvature | | rarefaction. Creep in lens |
| | | mounting. Drift in lens |
| | | manipulators. |
| dynamic lens field | >1 week | Glass compaction/ |
| curvature | | rarefaction. Creep in lens |
| | | mounting. Drift in lens |
| | | manipulators. |
| dynamic scan field | >1 day | Interferometer drift. |
| curvature (average) | | |

### SUMMARY

Methods and apparatus utilizing a posteriori adjustments to a projection imaging machine used in manufacturing of semiconductor integrated circuits are described. Methods include providing measurements of degradation in a lithography processing of a projection imaging tool or machine. The operation of the projection imaging tool is adjusted in response to the measurements. Then, a substrate is exposed using the adjusted projection imaging tool. Examples of types of degradation include lens aberrations, illumination source variation, variation in transmission as a function of transverse ray direction, scan synchronization error, lens distortion in a dynamically scanned field, static lens distortion, static lens field curvature as a function of field position, dynamic lens field curvature as a function of cross scan direction field position, dynamic height and roll error as a function of scan position, and wafer stage grid and yaw error.

The projection imaging machine or tool can be adjusted in a single adjustment. The projection imaging machine can also be adjusted in a series of sub-adjustments. Likewise, only a single machine may be adjusted, or multiple machines used in the manufacture of semiconductor integrated circuits may be adjusted. The measurements may be made using in-situ metrology tests.

A projection imaging tool may include a controller configured to receive measurements of degradation in lithography processing of the projection imaging tool. The controller can then adjust operation of the projection imaging tool in response to the received measurements. The adjusted projection imaging tool may then be used to expose a substrate.

Another method of semiconductor manufacture includes emulating a projection imaging machine utilizing a database including historical and current machine states. The projection imaging machine process capability is evaluated. It is then determined if the machine needs adjustment, and if it does determining what adjustments are desired. The adjustments may be made in a single adjustment, or as a series of sub-adjustments.

Another method of semiconductor manufacture includes emulating a plurality of projection imaging machines utilizing a database including historical and current states of the plurality of machines. Machine-to-machine processing capabilities are evaluated. Then it is determined if any of the machines need adjustment, and if any do then determining what adjustments are desired. The adjustments can be made in a single adjustment or as a series of sub-adjustments. In addition, a set of machines can be adjusted in a single step and other machines adjusted in a series of sub-adjustments. For example, machines that have been offline, or are new, may be adjusted in a single step and other machines adjusted in a series of sub-adjustments. Likewise, machines that have been offline, or are new, may be adjusted in a series of sub-adjustments and other machines adjusted in a single step. In other words, any combination of machines may be adjusted in a single step and any other combination of machines may be adjusted in a series of sub-adjustments.

Other features and advantages of the present invention should be apparent from the following description of the preferred embodiment, which illustrates, by way of example, the principles of the invention.

### BRIEF DESCRIPTION OF THE DRAWINGS

FIG. 1 shows the plan view of portion of DRAM memory cell structure.

FIG. 2 shows the AA cross section of DRAM memory cell showing vias, V, and bit lines.

FIG. 3 shows the AA cross section of FIG. 1 showing bit lines B misaligned by ΔX from vias, V.

FIG. 4 shows the cross section of generic prior art MOS integrated circuit transistor with metal, M, conductors making contact with Tungsten vias connected to source, drain, and gate.

FIG. 5 shows the cross section of MOS integrated circuit transistor showing misalignment of metal, M, layer from vias.

FIG. 6 shows prior art process steps for fabricating MOS integrated circuit transistor of FIG. 4 through 1^{st} metal layer.

FIG. 7 shows the projected image field in machine and two field points, A & B, separated in the X-direction.

FIG. 8 shows the Bossung or ISO—dose contours for gate linewidth and process variation windows at points A & B.

FIG. 9 illustrates a block diagram showing exemplary steps for utilizing a posteriori measurement to adjust a projection tool.

FIG. 10 shows exemplary steps for running an in-situ interferometer.

FIG. 11 shows exemplary steps for in-situ measurement of source radiant intensity.

FIG. 12 shows exemplary steps for in-situ measurement of an exit pupil transmission.

FIG. 13 shows exemplary steps for in-situ measurement of transverse scanning synchronization error.

FIG. 14 shows exemplary steps for in-situ measurement of dynamic lens distortion.

FIG. 15 shows exemplary steps for in-situ measurement of static lens field curvature.

FIG. 16 shows exemplary steps for in-situ measurement of static lens field curvature.

FIG. 17 shows exemplary steps for measurement of dynamic lens field curvature.

FIG. 18 shows exemplary process for determination of dynamic scan Z and roll synchronization error.

FIG. 19 shows an exemplary process for in-situ measurement of wafer stage grid and Yaw.

FIG. 20 is a block diagram of an example of a projection imaging tool.

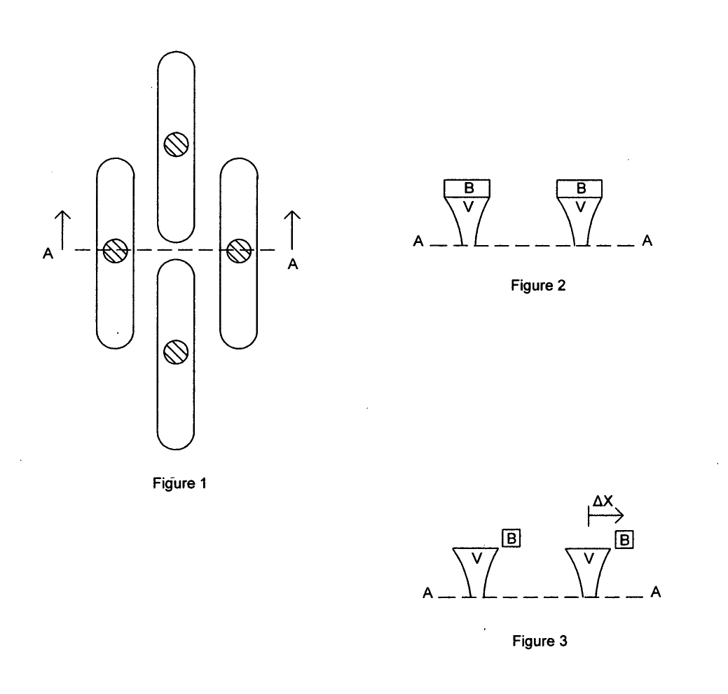

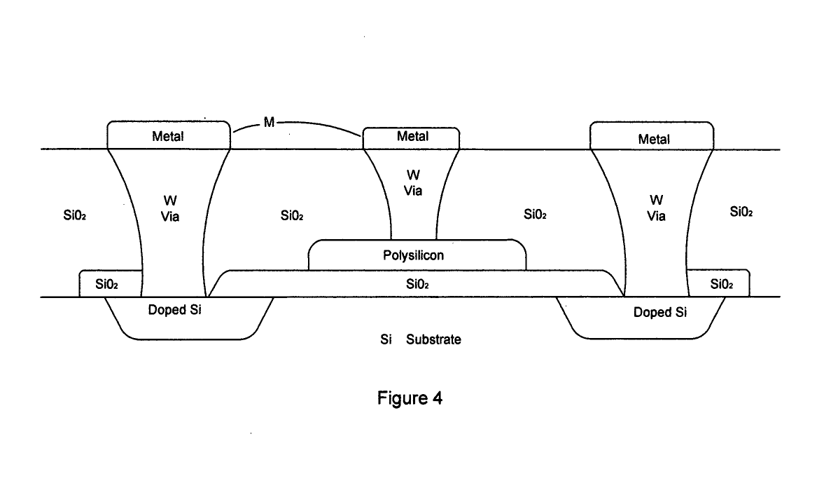

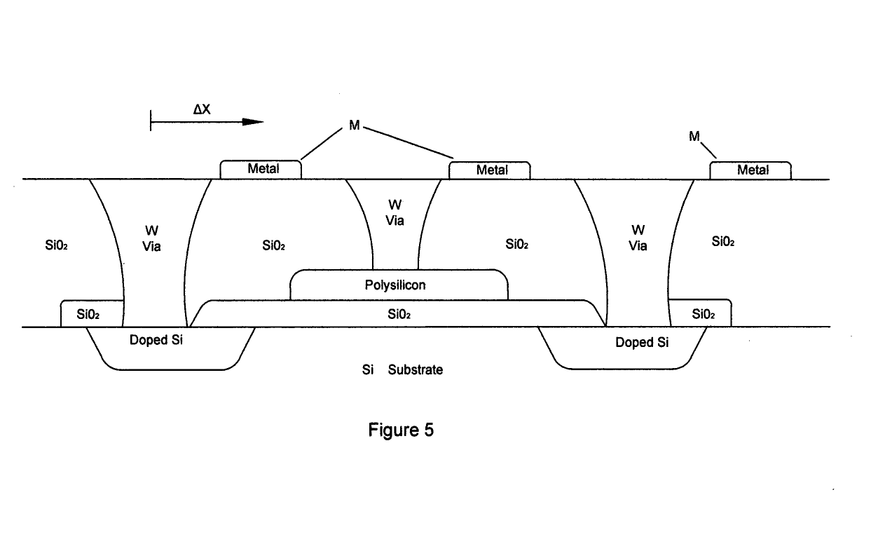

### DETAILED DESCRIPTION

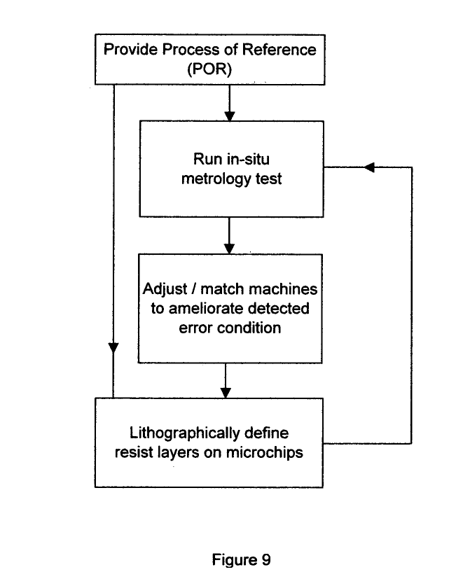

FIG. 9 illustrates exemplary steps for utilizing a posteriori measurements to adjust a projection imaging tool. Each step is discussed in detail below.

Provide Process of Reference

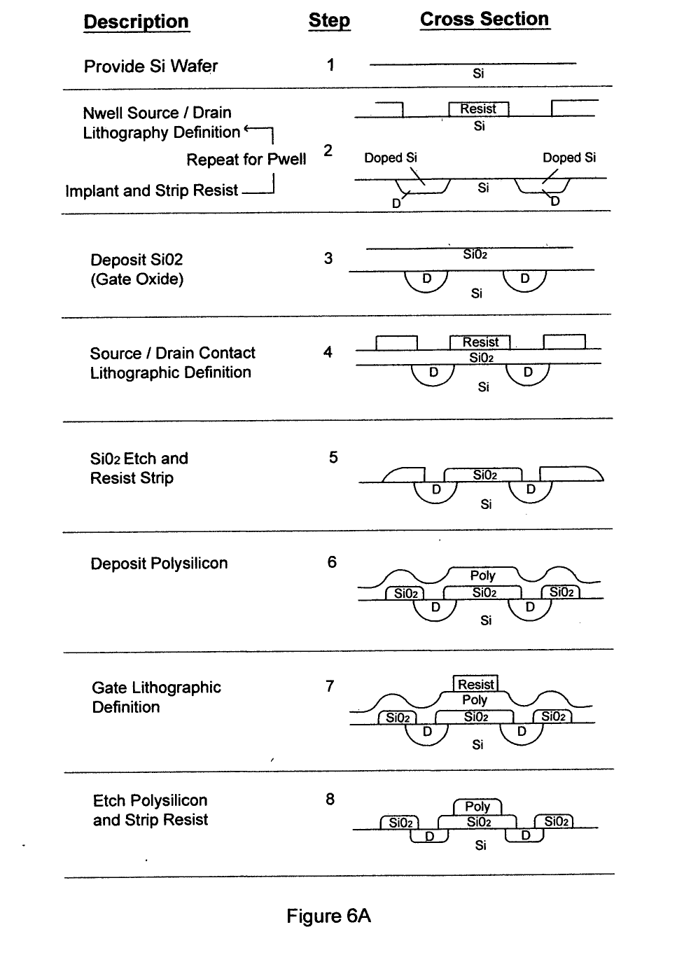

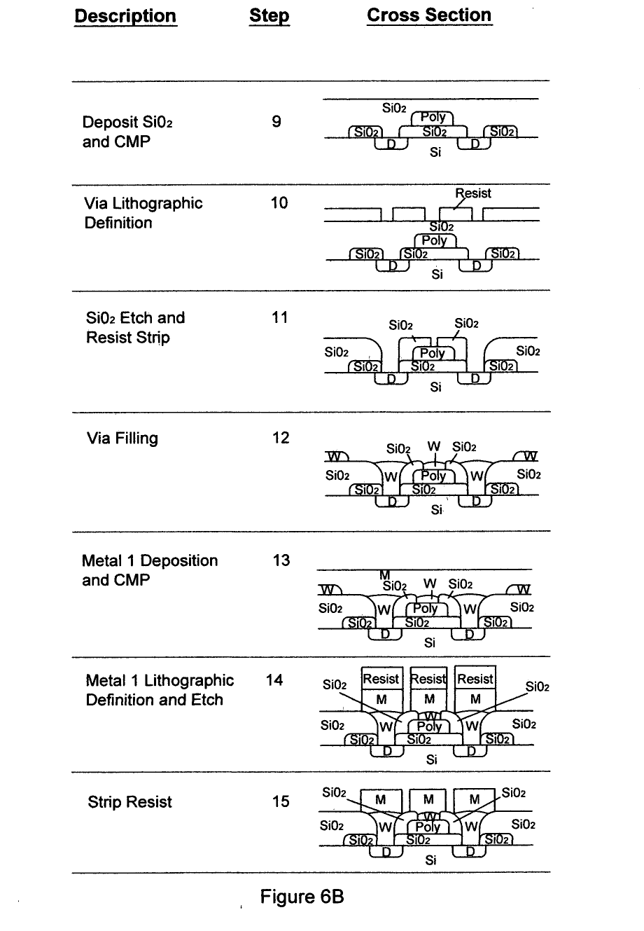

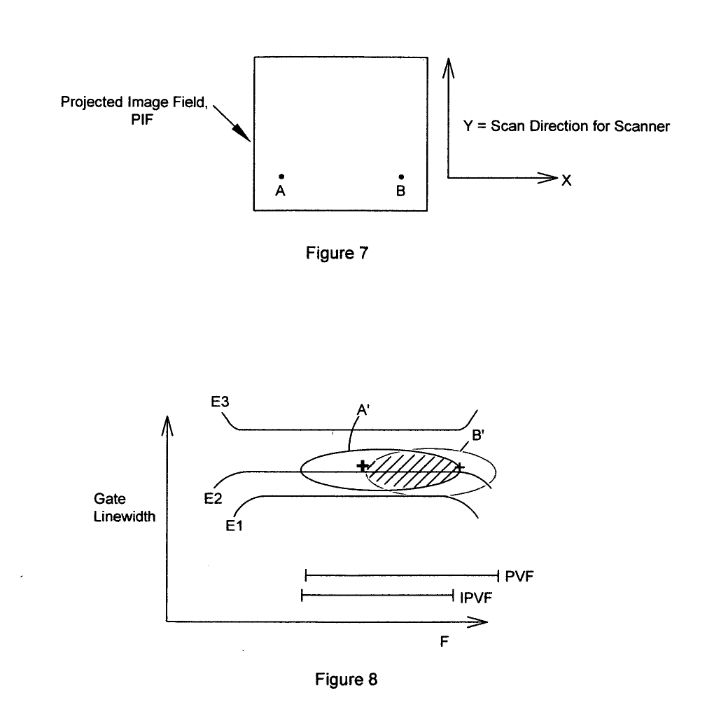

First, a process of reference (POR) for manufacturing a chip is provided. In abbreviated and truncated form, FIG. 6 is one example. Of greatest relevance to the present invention are the specific machine settings utilized. Table 2 shows an example of the relevant information extracted from the POR. Knowledge of machine setting indentifiers is required for running the in-situ metrology tests.

TABLE 2

| Lithographic | Machine | | | | | | FIELD | | |
|---|---|---|---|---|---|---|---|---|---|
| Layer | Model | XPOTYPE | LAID | SID | XID | TRID | SIZE/LAYOUT | Fₙₒₘ | E |
| Implant | S2071 | dynamic | abb1 | iid2 | iid2 | 8943 | size = 24 × 30 mm\hat{ }2/ | 200 | 40 |
| | | | | | | | pitch = 24.2 × 30.2/ | | |
| | | | | | | | fields = 4, 6, 6, 6, 4 | | |
| Implant | AT900.1 | dynamic | LADJ_11 | CON_0.6 | NA_0.8 | 8943 | size = 24 × 30 mm\hat{ }2/ | 200 | 40 |
| | | | | | | | pitch = 24.2 × 30.2/ | | |
| | | | | | | | fields = 4, 6, 6, 6, 4 | | |
| Source/ | S2071 | dynamic | abb1 | iid1 | iid1 | 2612 | size = 24 × 30 mm\hat{ }2/ | 230 | 60 |
| Drain | | | | | | | pitch = 24.2 × 30.2/ | | |
| Contacts | | | | | | | fields = 4, 6, 6, 6, 4 | | |
| Source/ | AT900.1 | dynamic | LADJ_11 | ANN_0.5_0.7 | NA_0.8 | 2612 | size = 24 × 30 mm\hat{ }2/ | 230 | 60 |
| Drain | | | | | | | pitch = 24.2 × 30.2/ | | |
| Contacts | | | | | | | fields = 4, 6, 6, 6, 4 | | |
| Gate | S2071 | dynamic | abb1 | iid1 | iid1 | 2612 | size = 24 × 30 mm\hat{ }2/ | 190 | 75 |
| Definition | | | | | | | pitch = 24.2 × 30.2/ | | |
| | | | | | | | fields = 4, 6, 6, 6, 4 | | |
| • | • | • | • | • | • | • | • | | |
| • | • | • | • | • | • | • | • | | |
| • | • | • | • | • | • | • | • | | |

In Table 2, the photographic layer is the name of the lithographic layer in process. The machine model is the machine model (not specific identity) used. The XPOTYPE (exposure type) is the static/dynamic for stepper/scanner models. The LAID (lens aberration identifier) is the keyword typed into or selected on the machine in the recipe or at exposure time that sets the lens manipulators or adjusters to a specific state. The SID (source identifier) similar to LAID but specifies the source configuration utilized. The XID (exit pupil identifier) similar to LAID but specifies the exit pupil numerical aperture utilized. The TRID (track identifier) similar to LAID but specifies the photoresist coat/develop recipe utilized. The FIELD SIZE/LAYOUT is the description of the exposure field size and pitch on wafer; the last entry describes layout; can also contain scanner direction and scan speed.

The Fₙₒₘ is the nominal machine focus in nanometers. The E is the nominal exposure dose in MJ/cm².

Run In-Situ Metrology Test

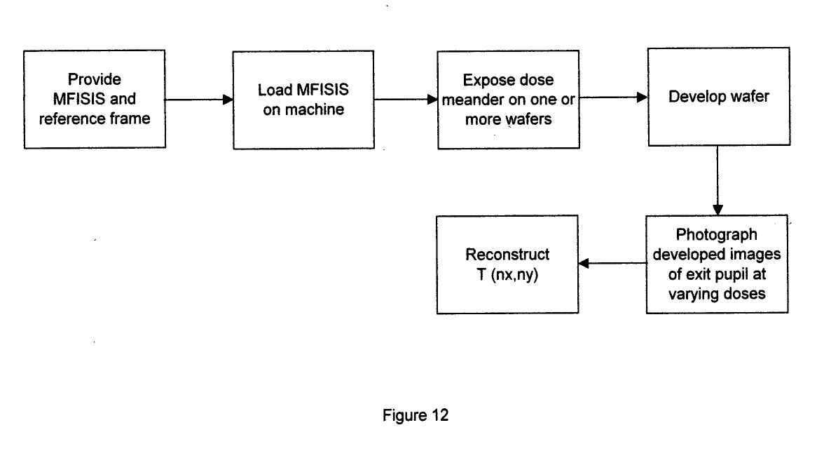

For each lithographic layer of the process deemed as critical (low C_{PK}) we run some or all of the in-situ metrology tests outlined and referenced in Table 3. As an example, Table 2 defines the lens manipulator settings (LAID) required for the Gate Definition Layer of process 80065. Machine model (not serial number or specific machine ID (MAID)) S2071 is qualified for that layer and the user would set or type in “abb1” on the machine console at exposure time or have it specified within the job deck for this process and layer on all machines of model S2071. To measure the lens aberrations, we would run each machine of model S2071 at LAID=“abb1” but with SID, XID, TRJD and field size/layout as described in U.S. Pat. No. 5,978,085, supra; the exposure portions of the process being detailed in FIG. 12A of that reference. Measuring the box-in-box patterns, we could then reconstruct the higher order (focus and above) lens aberrations. The resulting Zernike coefficients provide the basis for the next step.

TABLE 3
Causes of lithography cell process degradation and
in-situ measurement techniques for measuring causes

| Process | Resulting | |
|---|---|---|
| Variation | Process | Exemplary In-Situ Measurement |
| Cause | Degradation | Techniques of Cause |
| static/ | contrast loss, | A. Smith et al., “Apparatus, |
| dynamic | ACLV, image | Method of Measurement and |
| lens | shift | Method of Data Analysis for |
| aberrations | | Correction of Optical System”, |
| | | U.S. Pat. No. 5,828,455, issued |
| | | Oct. 27, 1998; A. Smith et al., |
| | | “Apparatus, Method of |
| | | Measurement and Method of Data |
| | | Analysis for Correction of Optical |
| | | System”, U.S. Pat. No. |
| | | 5,978,085, issued Nov. 2, |
| | | 1999; |
| | | A. Smith et al., “In-Situ |
| | | Interferometer Arrangement”, U.S. |
| | | Patent Application No. |
| | | 10/623,364, filed Jul. 18, 2003; B. |
| | | McArthur et al., “Method and |
| | | Apparatus for Proper Ordering of |
| | | Registration Data”, U.S. Patent |
| | | Application No. 10/039,426, Filed |
| | | Jan. 4, 2002 |
| source | image shift, | B. McArthur et al., “In-Situ |
| | contrast loss | Source Metrology Instrument and |
| | | Method of Use”, U.S. Pat. No. |
| | | 6,356,345, issued Mar. 12, 2002; |
| | | B. McArthur et al., “In-Situ |
| | | Source Metrology Instrument and |
| | | Method of Use”, U.S. Pat. No. |
| | | 6,741,338, issued May 25, 2004; |
| | | A. Smith et al., “Apparatus and |
| | | Method for High Resolution n-Situ |
| | | Illumination Source Measurement |
| | | in Projection Imaging Systems”, |
| | | U.S. Patent Application No. |
| | | 10/828,579, filed Apr. 20, 2004. |
| exit pupil | image shift, | A. Smith et al., “Method and |
| | resolution loss | Apparatus for Measurement of |
| | | Exit Pupil Transmittance”, U.S. |
| | | Patent Application No. |
| | | 11/105,799, filed Apr. 13, 2005 |
| static lens | image shift, | A. Smith et al., “Method & |
| distortion | layer to layer | Apparatus for Self-Referenced |
| | misalignment | Projection Lens Distortion |
| | | Mapping”, U.S. Pat. No. |
| | | 6,573,986, issued Jun. 2, 2003; A. |
| | | Smith et al., “Reference Wafer and |
| | | Process for Manufacturing Same”, |
| | | U.S. Pat. No. 6,699,627, issued |
| | | Mar. 2, 2004, |
| | | M. Hamatani et al., “Method of |
| | | Forming and Adjustin Optical |
| | | System and Exposure Apparatus, |
| | | and for Determining Specification |
| | | thereof and Related Computer |
| | | System”, European Patent |
| | | Application No. EP 1 231 516 A2, |
| | | 2002 |
| dynamic lens | image shift, | A. Smith et al., “Method and |
| distortion | layer to layer | Apparatus for Self-Referenced |
| | misalignment | Dynamic Step and Scan Intra- |
| | | Field Lens Distortion”, U.S. Patent |
| | | Application No. 10/252,020, filed |
| | | Sep. 20, 2002; EP 1 231 516 |
| | | A2, supra |
| dynamic scan | image shift, | A. Smith et al., “Method and |
| synchronization | layer to layer | Apparatus for Self-Referenced |
| | misalignment | Dynamic Step and Scan Intra- |
| | | Field Scanning Distortion”, U.S. |
| | | Patent Application No. |
| | | 10/252,021, filed Sep. 20, |
| | | 2002; EP 1 231 516 A2, supra |
| wafer stage | image shift, | A. Smith et al., “Method and |
| grid & yaw | layer to layer | Apparatus for Self-Referenced |
| | misalignment | Wafer Stage Positional Error |
| | | Mapping”, U.S. Pat. No. |
| | | 6,734,971, issued May 11, 2004; |
| | | EP 1 231 516 A2, supra |
| static lens | contrast loss, | A. Smith et al., “Apparatus and |
| field | image shift | Process for the Determination of |
| curvature | | Static Lens Field Curvature”, U.S. |
| | | Patent Application No. |
| | | 10/844,939, filed May 12, 2004 |
| dynamic lens | contrast loss, | A. Smith et al., “Apparatus and |
| field | image shift | Process for Determination of |
| curvature | | Dynamic Lens Field Curvature”, |
| | | U.S. Patent Application No. |
| | | 10/833,557, filed Apr. 28, 2004 |
| dynamic scan | contrast loss, | according to A. Smith et al., |
| field | image shift | “Apparatus and Process for |
| curvature | | Determination of Dynamic Scan |
| | | Field Curvature”, U.S. Patent |
| | | Application No. 10/833,781, filed |
| | | Apr. 28, 2004 |

All of the patents and patent applications listed in Table 2 are incorporated by reference herein their entirety.

Adjust Machines

At this point we assess the current state of adjustment of our machines and correct them. The preferred method for assessing the current state of machine adjustment is a direct machine emulation that utilizes a database containing the history and current machine state (see, A. Smith et al., “Method of Emulation of Lithographic Projection Tools”, U.S. patent application Ser. No. 11/111,302, filed Apr. 20, 2005). Since we are concerned with corrections to slowly varying (>1 day) machine characteristics in the emulator, we turn off rapid (<1 day) machine variations and look at individual or machine-to-machine process capability. Based on these results, we then determine which machines require adjustment and by what amount. Continuing the gate layer/lens aberration example above, using the nominal focus and exposure dose, we calculate the gate linewidth as a function of focus and exposure at a collection of field points representative of the exposure field size. Including random focus errors at each field point gives us the focus process variation. From this information we can determine whether the machine requires adjustment and by what amount.

Having decided how much we need to adjust each machine, there are a number of ways to implement the adjustment, some being: 1) adjust all machines at once, 2) gradually adjust machines into compliance, and 3) a combination of 1) and 2), immediately adjust machines outside the general distribution and gradually adjust the balance.

Adjust Machines

This provides the simplest and shortest schedule for machine improvement. Minimizing yield loss to WIP fabricated on an out of adjustment machine precludes this strategy in all cases. We are thinking particularly of transverse, layer-to-layer misalignments that can be temporarily exacerbated by relatively large adjustments to critical machines. However, once the method of the present invention is adopted on the factory floor, large adjustments of critical machines should be exceptional and their (and all other) machine adjustments can be done at once. It is typically only on the introduction of this method to the factory floor that we generally cannot adjust all machines at once.

Phase In Adjustment

On introduction of this method, to minimize the transient yield loss to WIP, the adjustments should be phased in over a number of steps and time. First, each setting of each machine is scored according to its deviation from the target value, Qₜₐᵣ, relative to upper (USL) and lower (LSL) specification limits according to:
S=4|Qₘₐₓ−Qₜₐᵣ|/(USL−LSL) Equation 1
where:
Qₘₐₓ=maximum deviation of quantity over machine printing field,
S=score,
The use of maximum is justified since we are looking at deterministic, explainable causes, not random ones.
The total number of adjustment phases is then:

$${N}_{adj} = ceiling ( \begin{matrix}max ( S ) \\ machine , process , \\ layers\end{matrix} ) \qquad Equation 2$$

where the maximum is taken over all machines, process and layers and ceiling is the next integer above the fractional part e.g., ceiling (3.1)=ceiling (3.9)=4.

The first adjustment is then made to machine settings with scores, S, falling within the range
N_{adj}−1<S≦N_{adj} Equation 3
Before the next adjustment we should wait a time period

$$Δ T = 6 * \frac{{T}_{fab}}{{N}_{layer}} \qquad Equation 4$$

where:
T_{fab}=average start to finish chip manufacturing time.
N_{layer}=number of lithographic layers (photoresist deposition and definition steps).
   After elapsed time ΔT, machine settings with scores within the range:
   N_{adj}−2<S≦N_{adj}—1 Equation 5
   are adjusted. This process of selective machine adjustment and waiting then continues to completion after a total of N_{adj} cycles.
   Mixed Adjustment

Mixed adjustment is a combination of phased in and immediate adjustment. New machines or existing machines that have been offline (≧ΔT time period) will be immediately adjusted to the factory standard. Phase-in adjustment will be applied to the balance. Note, that in a well controlled factory, the phase-in adjustment will typically require only a single step (N_{adj}=1) and in that case, is equivalent to immediate adjustment.

Print Lithographic Layers

In a continuously run factory, product will be emerging as we follow the above steps. So, lithographic layers are defined in photoresist and developed.

1^{st} Variation In-Situ Interferometer

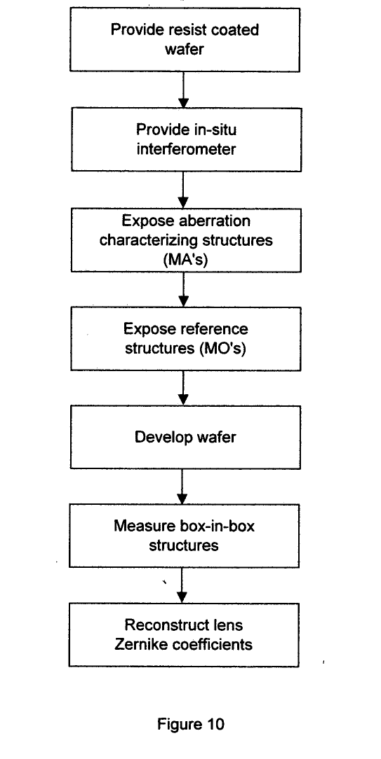

In this variation, an in-situ interferometer of the type described in U.S. Pat. Nos. 5,978,085 and 5,828,455, supra and U.S. patent application Ser. No. 10/623,364, supra may be used to measure the projection lens aberrations. Exemplary steps for running the in-situ interferometer are outlined in FIG. 10 of the present application. After getting the Zernike coefficients, the machine lens manipulators could be adjusted according to European Patent Application No. EP 1 231 516 A2, supra.

2^{nd} Variation In-Situ Source Metrology

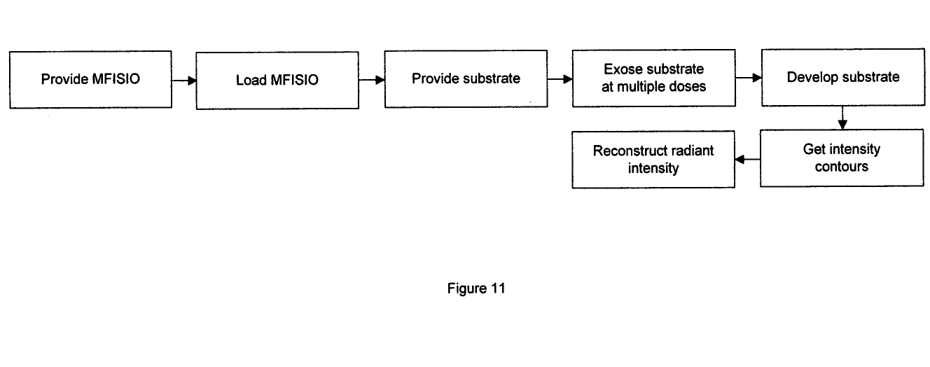

In this variation, an in-situ source metrology instrument of the type described in Reference U.S. Pat. No. 6,741,338, supra and U.S. patent application Ser. No. 10/828,579, supra may be used to measure the effective source radiant intensity, or effective source. FIG. 11 of the present application shows exemplary steps for performing this operation.

3^{rd} Variation, In-Situ Exit Pupil Mapping

In this variation, an in-situ exit pupil transmission mapper of the type described in U.S. patent application Ser. No. 11/105,799, supra may be used to measure the transmission as a function of transverse ray direction cosine T(nx,ny). From this, quantities such as the overall numerical aperture, NA as a function of field position can be assessed. FIG. 12 of the present application lays out exemplary steps for measuring the exit pupil transmission map.

4^{th} Variation, In-Situ Transverse Scanning Synchronization Error

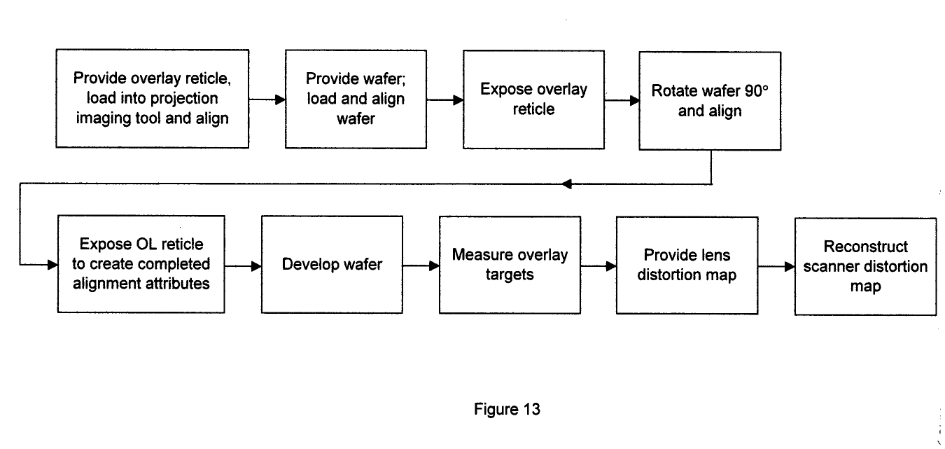

In this variation, a special reticle as described in U.S. patent application Ser. No. 10/252,021, supra and wafer with predisposed alignment marks may be used to determine the scanning synchronization error in X, Y and Yaw. FIG. 13 of the present application illustrates exemplary steps used to determine the scanning synchronization error.

5^{th} Variation of Main Embodiment, In-Situ Dynamic Lens Distortion (Dynamic a2, a3)

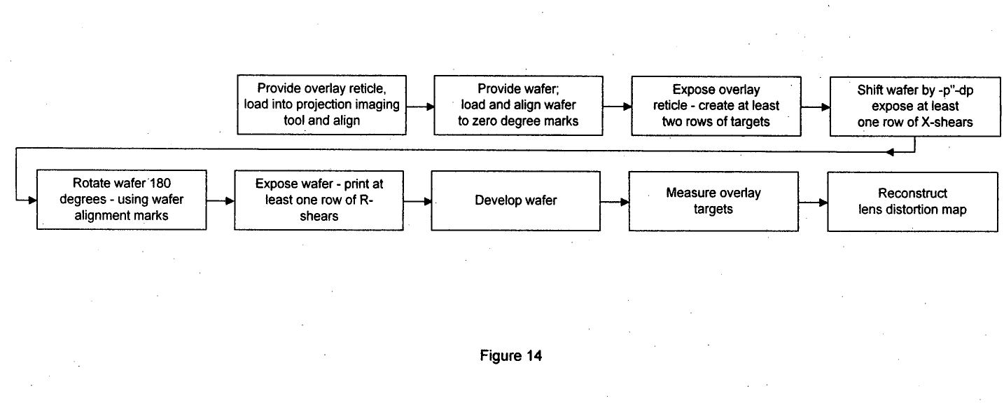

In this variation, the substantially similar reticle and wafer of the fourth variation are used to determine the contribution of lens distortion in a dynamically scanned field to overall overlay error. An exemplary technique for determining lens distortion is described in U.S. patent application Ser. No. 10/252,020. FIG. 14 of the present application illustrates exemplary steps for determining lens distortion.

6^{th} Variation, In-Situ Measurement of Static Lens Distortion (Static a2, a3)

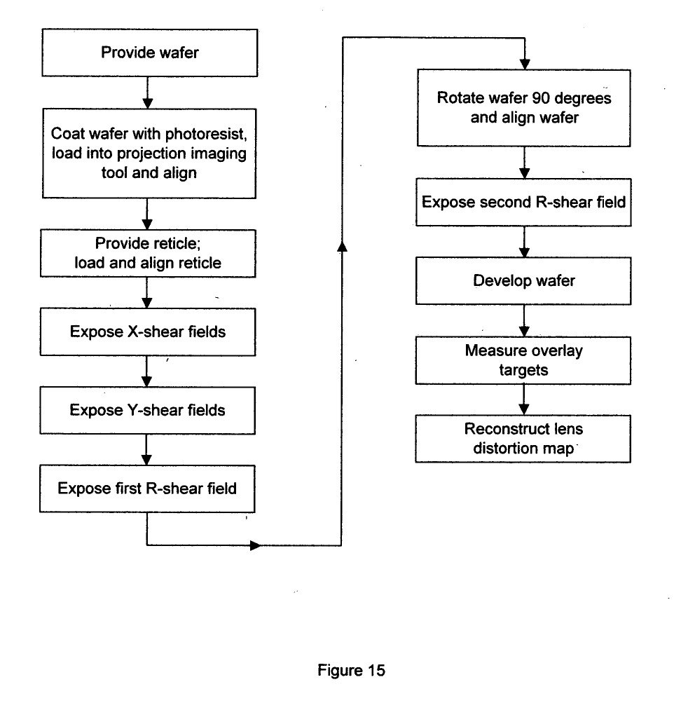

In this variation, a substantially similar reticle and wafer of the fourth variation may be used to determine the static lens distortion or tilt Zernike coefficients a2 and a3. An exemplary technique for determining this is described in Reference U.S. Pat. No. 6,573,986 B2. FIG. 15 of the present application illustrates exemplary steps for determining the static lens distortion.

7^{th} Variation, In-Situ Measurement of Static Lens Field Curvature

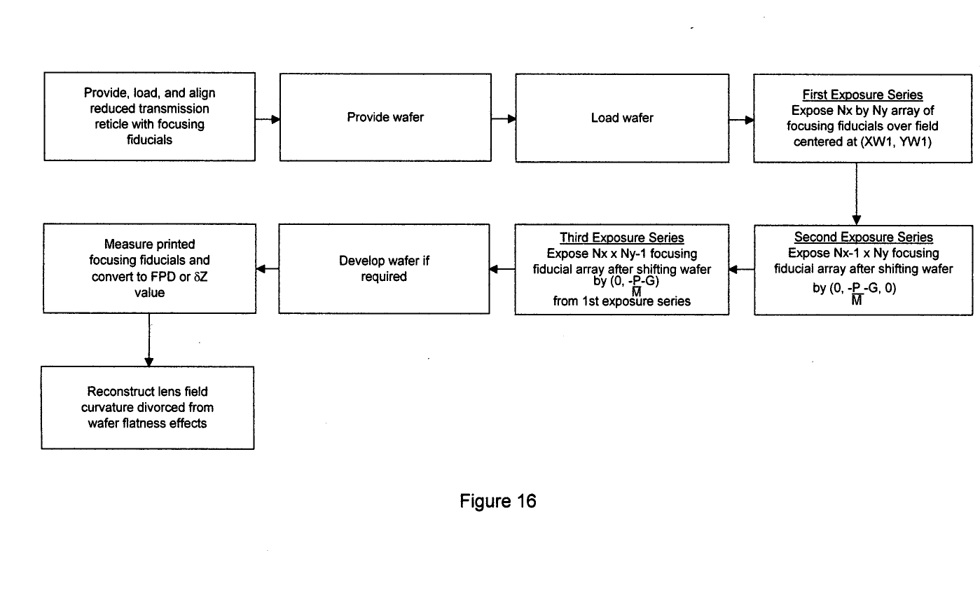

In this variation, a focusing fiducial reticle may be used to determine the static lens field curvature. U.S. patent application Ser. No. 10/844,939, supra describes an exemplary technique for performing this. The result is the static lens field curvature or focus Zernike (a4) as a function of field position. By using the method of U.S. patent application Ser. No. 10/844,939, supra, the final result is independent of wafer height variations. FIG. 16 of the present application illustrates exemplary steps for determining the static lens field curvature.

8^{th} Variation, In-Situ Measurement of Dynamic Lens Field Curvature

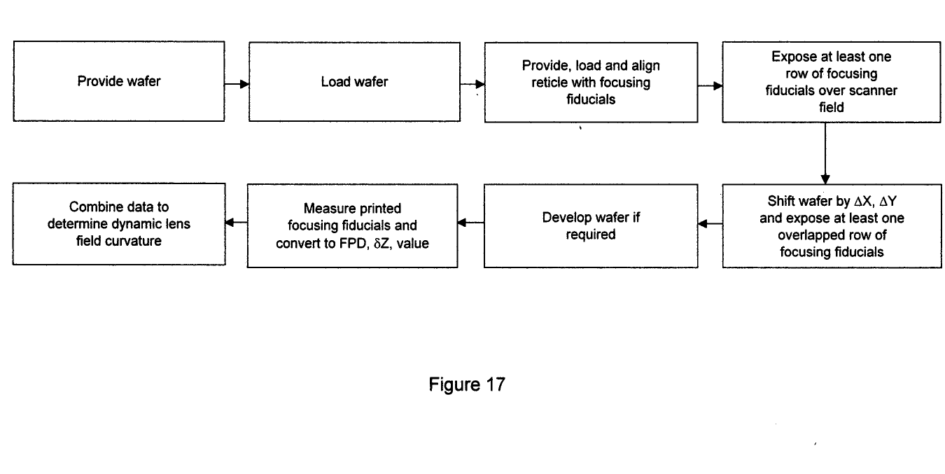

In this variation, a focusing fiducial reticle is provided and may be used to determine dynamic lens field curvature. U.S. patent application Ser. No. 10/833,557, supra illustrates an exemplary technique for determining lens field curvature. The result is the dynamic lens field curvature focus Zernike (a4) as a function of cross scan (X) direction field position. Using this technique, results independent of wafer height are obtained. FIG. 17 of the present application illustrates exemplary steps for determining the dynamic lens field curvature.

9^{th} Variation, In-Situ Measurement of Dynamic Z and Roll Synchronization Error

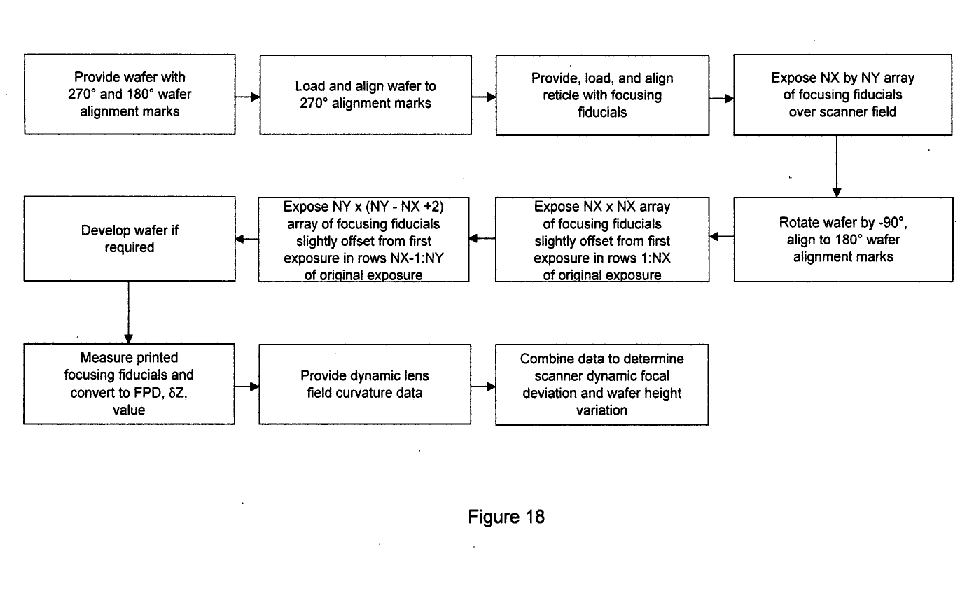

In this variation, a focusing fiducial reticle is provided and dynamic Z and roll synchronization error is determined. U.S. patent application Ser. No. 10/833,781, supra illustrates an exemplary technique for making these measurements. The result is the dynamic height (Z) and roll error as a function of the scan position (Y). FIG. 18 of the present application illustrates exemplary steps for determining dynamic Z and roll synchronization error.

10^{th} Variation, In-Situ Measurement of Wafer Stage Grid and Yaw Errors

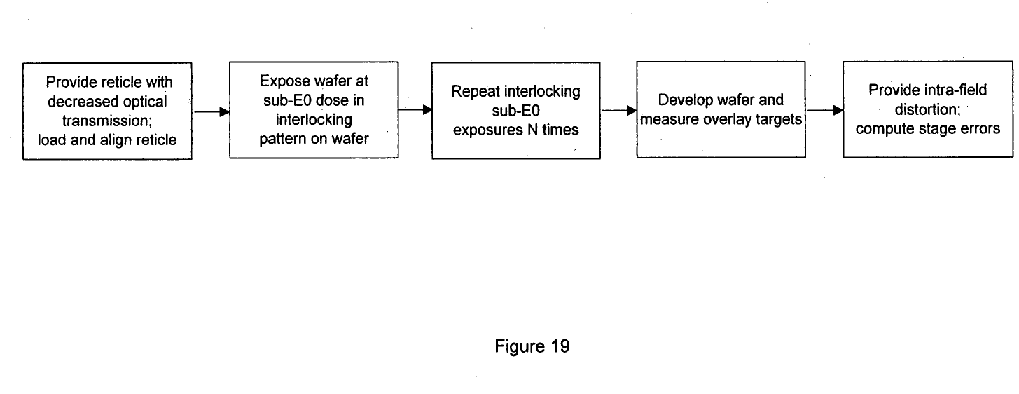

In this variation, a reticle is provided and exposed on a wafer to determine wafer stage grid and yaw errors illustrates an exemplary technique for making these measurements. U.S. Pat. No. 6,734,971, supra. The result is the wafer stage grid and Yaw stepping error. FIG. 19 of the present application illustrates exemplary steps for determining these errors.

Manufacturing of Integrated Circuits

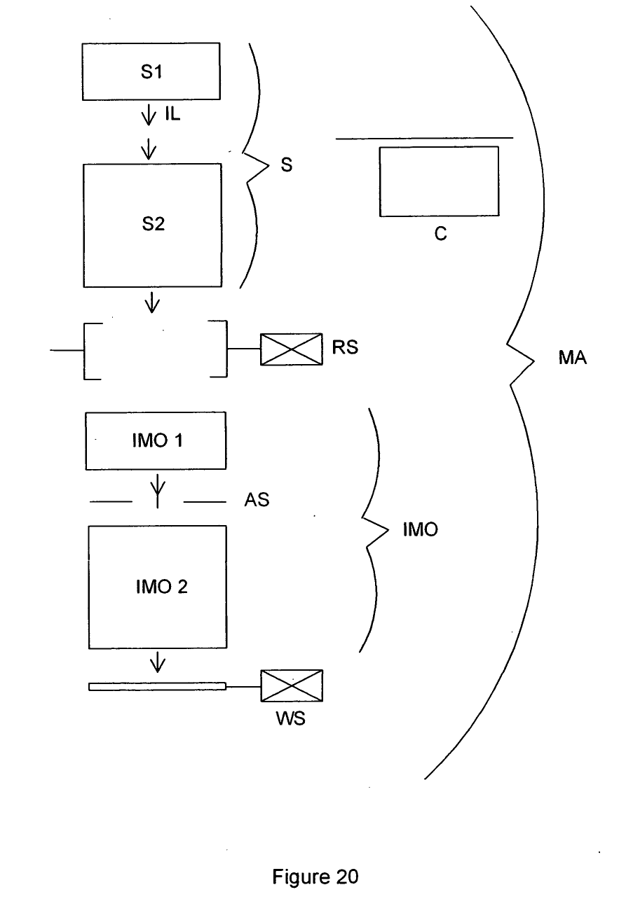

FIG. 20 is a schematic diagram of an example of a projection imaging tool or machine (MA) that can be used in the manufacturing of semiconductor integrated circuits. As shown in FIG. 20, the MA includes a light source S, a reticle stage RS, imaging objective IMO, wafer stage WS, and a controller C. The light source can include an illumination source S1 that outputs illumination light IL and an illumination conditioning S2 that conditions the light IL. The IMO includes an upper imaging objective IMO1, a lower imaging objective IMO2, and an aperture stop AS.

The controller C can be configured to receive measurements of degradation in lithography processing of the projection imaging tool. The controller can then adjust the operation of the projection imaging tool in response to the received measurements. For example, the controller can adjust the operation of the reticle stage RS, the illumination source S, the wafer stage WS, or other operations of the projection imaging tool. The adjusted imaging tool may then be used to expose a substrate, for example, a substrate that is positioned by the wafer stage WS at the output of the imaging objective IMO for a semiconductor integrated circuit manufacturing process.

The present invention has been described above in terms of a presently preferred embodiment so that an understanding of the present invention can be conveyed. There are, however, many configurations for semiconductor manufacturing not specifically described herein but with which the present invention is applicable. The present invention should therefore not be seen as limited to the particular embodiments described herein, but rather, it should be understood that the present invention has wide applicability with respect to semiconductor manufacturing generally. All modifications, variations, or equivalent arrangements and implementations that are within the scope of the attached claims should therefore be considered within the scope of the invention.

1. A method of manufacturing a semiconductor integrated circuit, the method comprising:
providing measurements of degradation in lithography processing of a projection imaging tool;
adjusting operation of the projection imaging tool in response to the measurements; and
exposing a substrate using the adjusted projection imaging tool for a semiconductor integrated circuit manufacturing process.

2. A method as defined in claim 1, wherein the degradation comprises lens aberrations.

3. A method as defined in claim 1, wherein the degradation comprises illumination source variation.

4. A method as defined in claim 1, wherein the degradation comprises variation in transmission as a function of transverse ray direction.

5. A method as defined in claim 1, wherein the degradation comprises scan synchronization error.

6. A method as defined in claim 1, wherein the degradation comprises lens distortion in a dynamically scanned field.

7. A method as defined in claim 1, wherein the degradation comprises static lens distortion.

8. A method as defined in claim 1, wherein the degradation comprises static lens field curvature as a function of field position.

9. A method as defined in claim 1, wherein the degradation comprises dynamic lens field curvature as a function of cross scan direction field position.

10. A method as defined in claim 1, wherein the degradation comprises dynamic height and roll error as a function of scan position.

11. A method as defined in claim 1, wherein the degradation comprises wafer stage grid and yaw error.

12. A method as defined in claim 1, wherein adjusting the operation of the projection imaging tool comprises adjusting the projection imaging tool in a single adjustment.

13. A method as defined in claim 1, wherein adjusting the operation of the projection imaging tool comprises adjusting the projection imaging tool in a series of sub-adjustments.

14. A method as defined in claim 1, further comprising adjusting multiple projection imaging tools.

15. A method as defined in claim 1, wherein the measurements are made using in-situ metrology tests.

16. A projection imaging tool comprising:
a wafer stage;
a controller configured to receive measurements of degradation in lithography processing of the projection imaging tool and to adjust operation of the projection imaging tool in response to the received measurements, wherein the adjusted projection imaging tool is used to expose a substrate at the wafer stage.

17. A projection imaging tool as defined in claim 16, wherein the degradation comprises lens aberrations.

18. A projection imaging tool as defined in claim 16, wherein the degradation comprises illumination source variation.

19. A projection imaging tool as defined in claim 16, wherein the degradation comprises variation in transmission as a function of transverse ray direction.

20. A projection imaging tool as defined in claim 16, wherein the degradation comprises scan synchronization error.

21. A projection imaging tool as defined in claim 16, wherein the degradation comprises lens distortion in a dynamically scanned field.

22. A projection imaging tool as defined in claim 16, wherein the degradation comprises static lens distortion.

23. A projection imaging tool as defined in claim 16, wherein the degradation comprises static lens field curvature as a function of field position.

24. A projection imaging tool as defined in claim 16, wherein the degradation comprises dynamic lens field curvature as a function of cross scan direction field position.

25. A projection imaging tool as defined in claim 16, wherein the degradation comprises dynamic height and roll error as a function of scan position.

26. A projection imaging tool as defined in claim 16, wherein the degradation comprises wafer stage grid and yaw error.

27. A projection imaging tool as defined in claim 16, wherein adjusting the operation of the projection imaging tool comprises adjusting the projection imaging tool in a single adjustment.

28. A projection imaging tool as defined in claim 16, wherein adjusting the operation of the projection imaging tool comprises adjusting the projection imaging tool in a series of sub-adjustments.

29. A projection imaging tool as defined in claim 16, further comprising adjusting multiple projection imaging tools.

30. A projection imaging tool as defined in claim 16, wherein the measurements are made using in-situ metrology tests.

31. A projection imaging tool comprising:
means for receiving measurements of degradation in a lithography processing of the projection imaging tool;
means for adjusting operation of the projection imaging tool in response to the received measurements; and
means for exposing a substrate using the adjusted projection imaging tool.

32. A method of semiconductor manufacture, the method comprising:
emulating a projection imaging machine utilizing a database comprising historical and current machine states;
evaluating the projection imaging machine process capability; and
determining if the machine needs adjustment and, if it does need adjustment, then determining what adjustments are desired.

33. A method as defined in claim 32, wherein adjustment of the projection imaging machine comprise adjusting the projection imaging machine in a single adjustment.

34. A method as defined in claim 32, wherein adjustment of the projection imaging machine comprises adjusting the projection imaging machine in a series of sub-adjustments.

35. A method of semiconductor manufacture, the method comprising:
emulating a plurality of projection imaging machines utilizing a database comprising historical and current states of the machines;
evaluating machine-to-machine processing capabilities; and
determining if any of the machines need adjustment and, if any machines need adjustment, then determining what adjustments are desired.

36. A method as defined in claim 35, wherein adjusting one of the plurality of projection imaging machines comprise adjusting the projection imaging machine in a single adjustment.

37. A method as defined in claim 35, wherein adjusting one of the plurality of projection imaging machines comprises adjusting the projection imaging machine in a series of sub-adjustments.

38. A method as defined in claim 35, wherein adjusting projection imaging machines comprises adjusting a set of machines in a single step and adjusting other machines in a series of sub-adjustments.

39. A method as defined in claim 38, wherein the set of machines adjusted in a single step comprise machines that have been offline.

40. A method as defined in claim 38, wherein the set of machines adjusted in a single step comprises new machines.
